(19) United States
(12) Patent Application Publication
(10) Pub. No.: US 2006/0203262 A1
(43) Pub. Date: Sep. 14, 2006

(54) Beam light scanning apparatus, image forming apparatus, and method for controlling generation of beam light

(75) Inventors: Daisuke Ishikawa, Shizuoka-ken (JP); Koji Tanimoto, Shizuoka-Ken (JP); Kenichi Komiya, Kanagawa-Ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/237,902

(22) Filed: Sep. 29, 2005

(30) Foreign Application Priority Data
Mar. 11, 2005 (JP) 2005-069858

(51) Int. Cl. G06K 15/12

(52) U.S. Cl. 358/1.7

(57) ABSTRACT

A beam light scanning apparatus capable of always stably maintaining the operations of writing and reading data of each line in a normal state while suppressing an increase of the parts cost. The beam light scanning apparatus includes a laser for emitting a beam light for scan. The apparatus further includes a memory allowing writing and reading of data based on image information per pixel read from a target image, units for writing, into the memory, the data of the target image in each line in a direction of main scan in response to a line sync signal, and units for reading the data out of the memory during the same processing cycle corresponding to the line sync signal after a delay of a predetermined time from writing of the data. A control unit converts the read data to a PWM modulated signal in accordance with the data and applies the PWM modulated signal as a driving signal to the laser.

### BACKGROUND OF THE INVENTION

1. Field of the Invention

The present invention relates to a beam light scanning apparatus for generating a beam light for scan, an image forming apparatus equipped with the beam light scanning apparatus, and a method for controlling generation of a beam light. More particularly, the present invention relates to a beam light scanning apparatus, an image forming apparatus, and a method for controlling generation of a beam light, which are suitable for, e.g., a copying machine and are capable of adjusting the transfer timing of data corresponding to pixel information of each line in a transfer path extending until a driver for driving a light emitting unit that emits the beam light.

2. Description of the Related Art

Recently, various types of image forming apparatuses, such as digital copying machines and laser printers, have been developed and put already into practice in which an image is formed with a combination of scanned exposure using a laser beam light (hereinafter referred to simply as a “beam light”) and an electrophotographic process.

That type of image forming apparatus operates based on the principle that, as disclosed in, e.g., Patent Document 1; Japanese Unexamined Patent Application Publication No. 2001-91872, the surface of a single photoconductor drum is scanned and exposed at the same time using the beam light to form a single electrostatic latent image on the surface of the photoconductor drum, and the electrostatic latent image is transferred to a sheet of paper.

In the field of that type of image forming apparatus, there has recently been a demand for, in particular, a speedup and finer resolution in image formation. To meet such a demand, it has also been demanded to not only increase the number of lines of the beam light for scan, but also raise the modulation frequency of a signal for driving the beam light. That demand entails the necessity of transmitting both of data transferred from the side of a system, which includes a scanner unit for reading image information of a target image and an image processing unit, and a timing signal, which is used for forming the image corresponding to the transmitted data, to a beam light driving circuit, i.e., a pulse width modulator (hereinafter abbreviated to a “PWM”), in a high-speed and reliable manner. One known solution is to temporarily store, into a memory, the data transferred from the system side including the scanner unit and the image processing unit, and then to read the written data out of the memory. In that case, the operation of writing the data into the memory and the operation of reading the data out of the memory require to be finished during a period of image formation for the data of each one line.

Patent Document 2; Japanese Unexamined Patent Application Publication No. 6-149655 discloses one known example of a circuit configuration for realizing the above-described solution of writing and reading the data using the memory. The circuit disclosed in Patent Document 2 includes a memory for buffering a transfer speed difference between respective data transfer paths in the data reading side and the data writing side, and an arbitration circuit for arbitrating the timings of writing and reading the data with respect to the memory. The arbitration circuit has a write control terminal and a read control terminal, and selects a write or read enable state depending on which one of a write control signal and a read control signal arrives at the corresponding terminal at earlier timing. Therefore, the write or read enable state can be selected by controlling the timings of the write control signal and the read control signal.

In image forming apparatuses such as digital copying machines and laser printers, if data is read from a memory before the data is written into the memory, desired data cannot be read and the equivalent relationship between writing and reading with respect to the number of data in the memory is destroyed, thus resulting in a problem that a desired image cannot be formed.

One conceivable solution for overcoming such a problem is to employ the timing adjusting method disclosed in Patent Document 2. In an image forming apparatus employing the disclosed method, however, due consideration is not paid to conditions regarding data write and read positions in the memory and conditions regarding the relationship between the number of written data and the number of read data. For that reason, if the number of written data and the number of read data are mismatched with each other in one line, data is read in spite of the memory being empty or data overflows, thus resulting in deterioration of image quality of an output image.

### SUMMARY OF THE INVENTION

In view of the above-mentioned problems in the state of the art, an object of the present invention is to provide a beam light scanning apparatus, an image forming apparatus, and a method for controlling generation of a beam light, which can stably maintain the operation of writing image data of each line into a memory and the operation of reading the data out of the memory in a normal state.

To achieve the above object, a beam light scanning apparatus according to an aspect of the present invention includes a light emitting unit for emitting a beam light for scan; a memory allowing writing and reading of data based on image information per pixel read from a target image; a data writing unit for writing, into the memory, the data of the target image in each line in a direction of main scan in response to a line sync signal; a data reading unit for reading the data out of the memory during the same processing cycle corresponding to the line sync signal after a delay of a predetermined time from writing of the data by the data writing unit; and a control unit for controlling operation of the light emitting unit by a driving signal which is generated based on the data read by the data reading unit.

According to the present invention, it is possible to stably maintain the operation of writing image data of each line into a memory and the operation of reading the data out of the memory in a normal state.

### BRIEF DESCRIPTION OF THE DRAWINGS

FIG. 1 is a schematic view for explaining an outline of a digital copying machine as one example of an image forming apparatus according to one embodiment of the present invention;

FIG. 2 is a schematic view for explaining an optical system of the image forming apparatus according to the embodiment;

FIG. 3 is a block diagram for explaining an outline of a control system according to the embodiment;

FIG. 4 is a block diagram showing the configuration of a laser control unit in the control system according to the embodiment;

FIG. 5 is a timing chart for explaining the concept of delay control executed in the embodiment;

FIG. 6 is a timing chart for explaining details of the delay control executed in the embodiment;

FIG. 7 is a block diagram showing the configuration of a laser control unit in a control system according to the related art;

FIG. 8 is a timing chart for explaining one example of a drawback caused with delay control executed in a main control unit according to the related art;

FIG. 9 is a timing chart for explaining another example of drawbacks caused with the delay control executed in a main control unit according to the related art; and

FIG. 10 is a timing chart for explaining still another example of drawbacks caused with delay control executed in a main control unit according to the related art.

### DESCRIPTION OF THE PREFERRED EMBODIMENTS

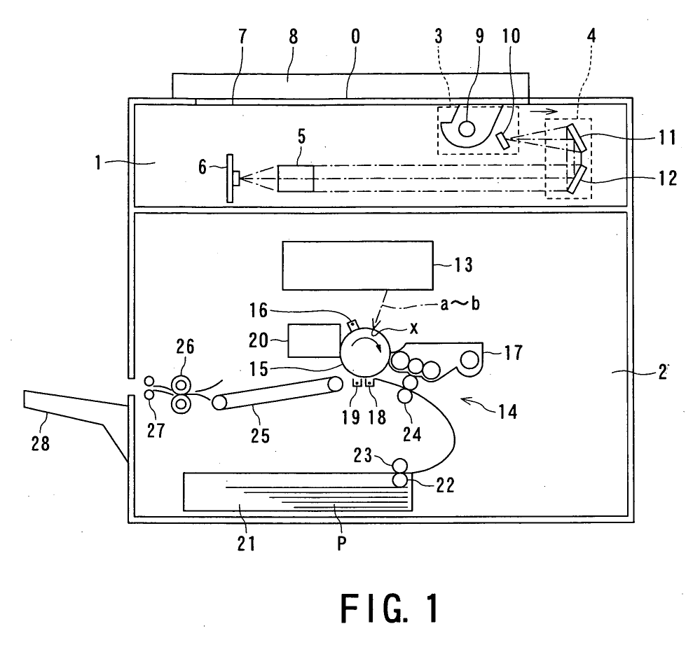

One embodiment of the present invention will be described below with reference to FIGS. 1-6. In the following, the embodiment is described in connection with a digital copying machine that embodies not only a beam light scanning apparatus according to the present invention, but also an image forming apparatus equipped with the beam light scanning apparatus. The digital copying machine may be practiced as a standalone machine or as a part of an MFP system.

FIG. 1 schematically shows the construction of the digital copying machine. The digital copying machine includes, for example, a scanner unit 1 serving as image reading means and a printer unit 2 serving as image forming means. The scanner unit 1 includes a first carriage 3 and a second carriage 4 which are movable in the direction indicated by an arrow, a focusing lens 5, a photoelectric transducer 6, etc.

In the construction shown in FIG. 1, an original document O is placed on a document platen 7 made of a transparent glass to face downward. The basis for placement of the document O is defined such that a center basis is given by the front right side of the document platen 7 as viewed in the direction of a shorter side of the document platen 7. The document O is pressed against the document platen 7 by a document fixing cover 8 attached to be capable of freely opening and closing.

The document O is illuminated by a light source 9, and a light reflected by the document O is collected onto a light receiving surface of the photoelectric transducer 6 through mirrors 10, 11 and 12 and the focusing lens 5. The first carriage 3 mounting the light source 9 and the mirror 10 thereon and the second carriage 4 mounting the mirrors 11, 12 thereon are moved at a relative speed of 2:1 so that an optical path length is held constant. The first carriage 3 and the second carriage 4 are moved by a carriage driving motor (not shown) in the direction toward the right from the left, as viewed on FIG. 1, in sync with a read timing signal.

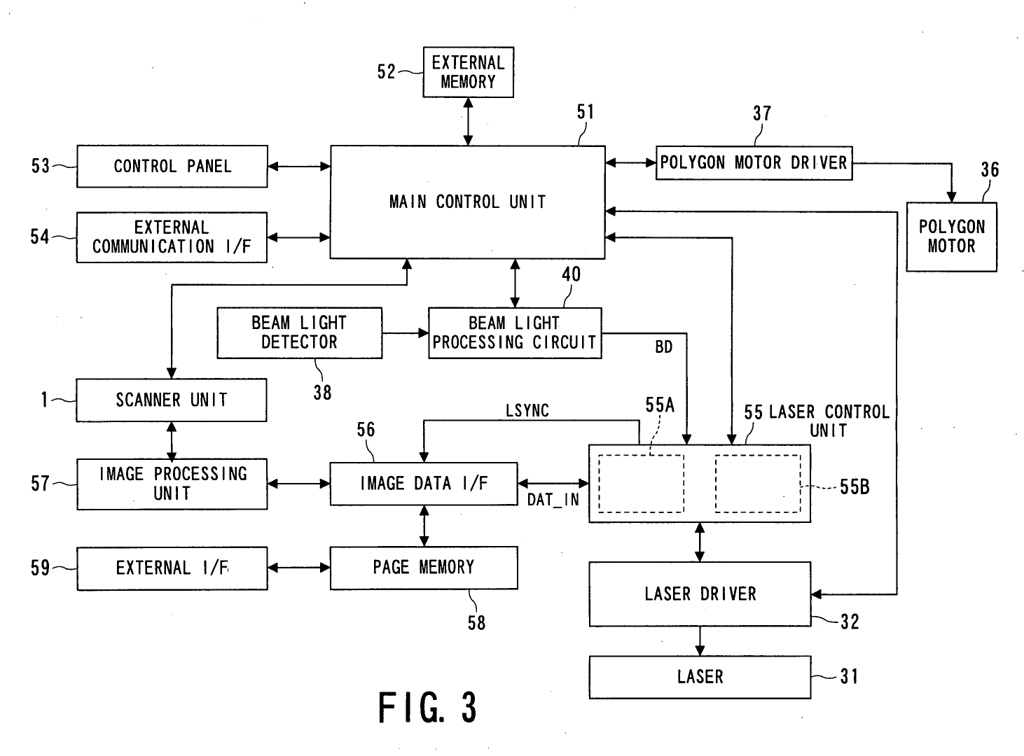

In such a way, an image of the document O placed on the document platen 7 is sequentially read by the scanner unit 1 line by line. A read output is converted in an image processing unit 57 (see FIG. 3) to a digital image signal of, e.g., 8 bits, which represents light and dark of the image.

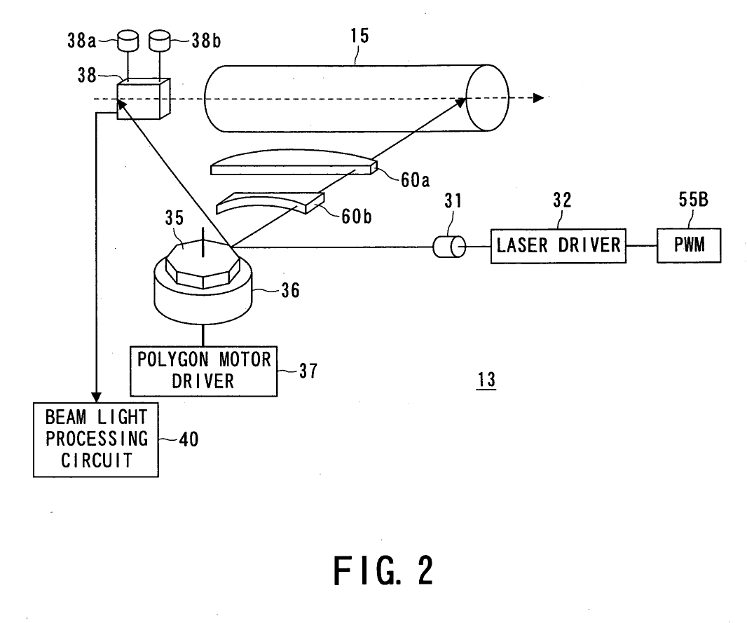

The printer unit 2 includes an optical system unit 13 and an image forming section 14 capable of forming an image on a sheet of paper P, i.e., a medium on which the image is to be formed, according to the electrophotographic process in combination with the optical system unit 13. More specifically, an image signal read by the scanner unit 1 from the document O is processed by the image processing unit 57 (see FIG. 3) and then converted to a laser beam light (hereinafter referred to simply as a “beam light”) emitted from a semiconductor laser oscillator 31 (hereinafter referred to simply as a “laser”) 31 (see FIG. 2). While this embodiment employs, by way of example, a single beam optical system including one laser, a multi-beam optical system using a plurality (e.g., two) of lasers may also be used instead.

Although details of the optical system unit 13 will be described later with reference to FIG. 2, one laser 31 disposed in the optical system unit 13 is operated so as to emit a beam light in accordance with a laser modulation signal outputted from the image processing unit 57, and the emitted beam light is reflected by a polygon mirror to become a scan light that is outputted externally of the optical system unit 13.

The beam light irradiated from the optical system unit 13 is focused as the scan light in the form of a spot having a required resolution at an exposure position X (see FIG. 1) on a photoconductor drum 15, which serves as an image carrier, for performing scan and exposure line by line. As a result, an electrostatic latent image corresponding to the image signal is formed on the surface of the photoconductor drum 15.

Around the photoconductor drum 15, there are disposed an electrical charger 16 for charging the drum surface with electricity, a developing unit 17, a transfer charger 18, a peeling-off charger 19, a cleaner 20, and so on. The photoconductor drum 15 is rotated at a predetermined outer circumferential speed by a driving motor (not shown) and is charged with electricity by the electrical charger 16 disposed opposite to the drum surface. At the exposure position X on the photoconductor drum 15 thus charged with electricity, the beam light (scan light) is focused in the form of a spot.

The electrostatic latent image formed on the surface of the photoconductor drum 15 is developed with a toner (developer) supplied from the developing unit 17. With the rotation of the photoconductor drum 15 including the toner image formed with the development, the toner image is transferred at a transfer position by the transfer charger 18 to the sheet of paper P that is supplied at matched timing from a paper supply system.

In the paper supply system, sheets of paper P set in a paper supply cassette 21 disposed at the bottom are individually separated and supplied one by one with a combination of a paper feed roller 22 and a separating roller 23. After reaching a register roller 24, the sheet of paper P is further fed to the transfer position at the predetermined timing. Downstream of the transfer charger 18, there are disposed a paper conveying mechanism 25, a fusing unit 26, and a paper ejection roller 27 for ejecting the sheet of paper P on which the image has been formed. The toner image transferred to the sheet of paper P is fused and fixed by the fusing unit 26. Then, the sheet of paper P is ejected through a paper ejection roller 27 onto an ejected paper tray 28 disposed outside the machine.

The photoconductor drum 15 from which the toner image has been transferred to the sheet of paper P is returned to an initial state after the toner remaining on the drum surface has been removed by the cleaner 20, followed by coming into a standby state for a next cycle of image formation.

By repeating the above-described process steps, the image forming operation is successively performed.

Thus, the document O placed on the document platen 7 is read by the scanner unit 1, and read information is recorded as a toner image on the sheet of paper P after being subjected to a series of the process steps in the printer unit 2.

The optical system unit 13 will be described below.

FIG. 2 shows components of the optical system unit 13 and the positional relationships between those components and the photoconductor drum 15. The optical system unit 13 includes, as mentioned above, the laser (semiconductor laser oscillator) 31 serving as one beam light emitting means. The laser 31 emits the beam light to perform the image formation in units of one scan line. The laser 31 is driven by a laser driver 32, and the beam light emitted from the laser 31 impinges upon a polygon mirror 35, i.e., a multi-faced rotating mirror, after passing through a collimator lens (not shown).

The polygon mirror 35 is rotated at a constant speed by a polygon motor 36 that is driven by a polygon motor driver 37. Therefore, the light reflected by the polygon mirror 35 is scanned in a certain direction at an angular speed determined depending on the rotation speed of the polygon motor 36. The beam light scanned by the polygon mirror 35 passes through an f-θ lens (not shown) having a particular f-θ characteristic. As a result, the beam light scans a light receiving surface of a beam light detector 38 and the surface of the photoconductor drum 15 at a constant speed. The beam light detector 38 functions as beam light position detecting means, beam-light passage timing detecting means, and beam light power detecting means.

The laser driver 32 includes an APC circuit so that the laser 31 is always steadily operated to emit the beam light at a power level of the emitted beam light set by a main control unit (CPU) 51 (described later).

Also, the beam light detector 38 is provided with adjustment motors 38a, 38b for adjusting the mount position of the beam light detector 38 and the inclination thereof with respect to the scan direction of the beam light.

The beam light detector 38 detects, as mentioned above, the passage position, the passage timing and the power (light intensity) of the beam light scanning the surface of the photoconductor drum 15. The beam light detector 38 is disposed near one end of the photoconductor drum 15 such that the light receiving surface of the beam light detector 38 is equivalent to the surface of the photoconductor drum 15 from the positional aspect. Control of the light emission power (light intensity) of the laser 31 and control of the light emission timing (i.e., control of the image formation position in the direction of main scan) are executed in accordance with a detected signal from the beam light detector 38. In particular, the control of the light emission timing includes delay control in transfer of image data according to the present invention. This delay control is executed using a horizontal sync signal (BD) outputted from the beam light detector 38 with the function of detecting the passage position of the beam light.

The beam light detector 38 is connected to a beam light processing circuit 40 for producing signals to execute the above-mentioned control. The beam light processing circuit 40 receives various detected signals from the beam light detector 38 and supplies detection pulse signals (including the horizontal sync signal (BD)), which represents the passage position and the passage timing of the beam light, to the main control unit 51 and a laser control unit 55 described later.

A control system will be described below.

FIG. 3 shows the control system primarily executing control of the single beam optical system. The control system includes the main control unit 51 for executing overall electric control in the copying machine. The main control unit 51 includes, for example, a CPU, a memory, and a clock circuit (all not shown). Also, connected to the main control unit 51 are an external memory 52, a control panel 53, an external communication interface (I/F) 54, the laser driver 32, the polygon motor driver 37, the beam light processing circuit 40, the scanner unit 1, and the laser control unit 55 each in a communicable manner.

Among those components, the laser control unit 55 is connected to not only the beam light processing circuit 40, but also to an image data I/F 56, as shown in FIG. 3. The image processing unit 57 is connected to the laser control unit 55 via the image data I/F 56 so that the image data can be outputted to the laser control unit 55. Further, an external I/F 59 is connected to the image data I/F 56 via a page memory 58.

In copying operation, the image of the document O set on the document platen 7 is read by the scanner unit 1 and sent to the image processing unit 57. The image processing unit 57 performs predetermined known processing, such as a shading modification, various filtering processes, a degradation process and a gamma modification, and then outputs processed image data to the image data I/F 56.

The image data outputted from the image processing unit 57 is sent to the image data I/F 56. The image data I/F 56 sends the image data to the laser control unit 55.

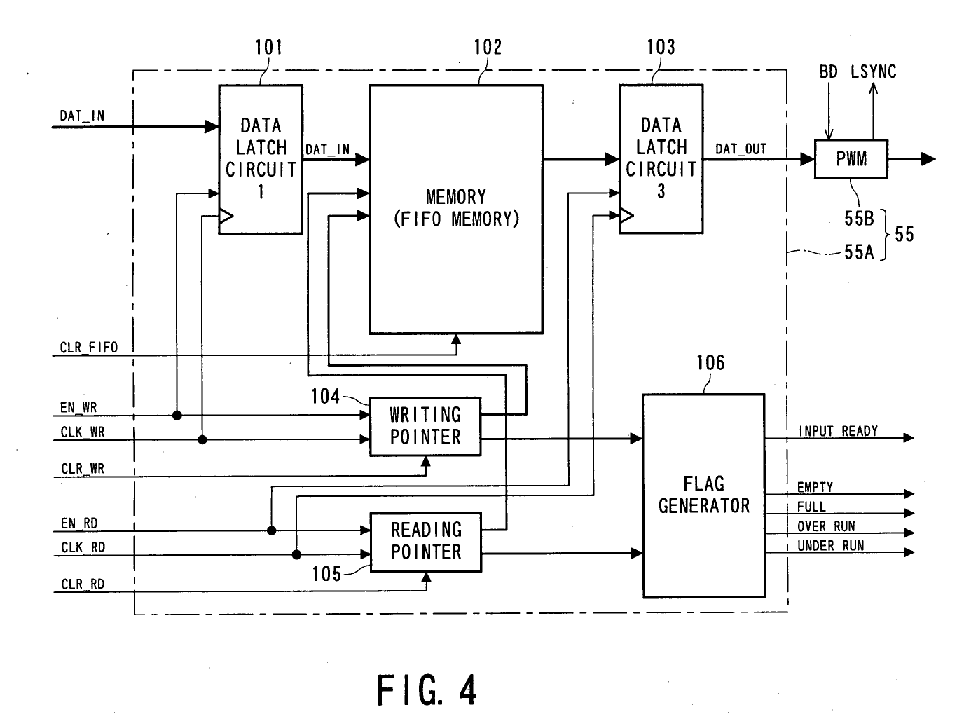

The laser control unit 55 includes, as shown in FIG. 4, a delay control circuit 55A for transferring the image data after a delay, which has been inputted via the image data I/F 56, and a PWM circuit 55B for executing PWM on the image data delayed by the delay control circuit 55A, to thereby produce a modulated signal.

Among those components, the delay control circuit 55A includes a data latch circuit 101 for writing, a memory 102 capable of writing and reading data on the FIFO basis, a data latch circuit 103 for reading, a writing pointer 104 for use in data write control (regarding the number of written data and the data written positions), a reading pointer 105 for use in data read control (regarding the number of read data and the data read positions), and a flag generator 106 for generating flag information indicating the state of the delay control.

Image data (DAT_IN), a write enable signal (EN_WR), and a write data clock (CLK_WR) are applied to the data latch circuit 101 for writing. A read enable signal (EN_RD) and a read data clock (CLK_RD) are applied to the data latch circuit 103 for reading. The write enable signal (EN_WR) and the write data clock (CLK_WR) are also applied to the writing pointer 104. The read enable signal (EN_RD) and the read data clock (CLK_RD) are also applied to the reading pointer 105.

With such an arrangement, the image data (DAT_IN) is latched by the data latch circuit 101 in sync with the write enable signal (EN_WR) and the write data clock (CLK_WR). The latched data is written into the memory 102 in accordance with an output value of the writing pointer 104. On the other hand, the image data is read out of the memory 102 in accordance with an output value of the reading pointer 105 and in sync with the read enable signal (EN_RD) and the read data clock (CLK_RD). The read image data is latched, as image data (DAT_OUT) having been subjected to the delay control, by the data latch circuit 103 for data reading. The latched data is transferred to the PWM circuit 55B as the image data (DAT_OUT) having been subjected to the delay control.

In this embodiment, the write enable signal (EN_WR), the write data clock (CLK_WR), the read enable signal (EN_RD), and the read data clock (CLK_RD) are supplied from the main control unit 51. However, a circuit for generating those enable signals and clocks may be disposed in the laser control unit 55.

The flag generator 106 generates, as mentioned above, flags indicating the states of the memory 102 as follows:

EMPTY: the difference between the writing pointer value and the reading pointer value is 0 (memory is empty)

FULL: the writing pointer value is matched with a memory maximum value (memory is full)

OVER RUN: the writing pointer value exceeds the memory maximum value

UNDER RUN: the reading pointer value exceeds a memory lower limit value

INPUT READY: state other than the above

The signals indicating those flag states are sent to the main control unit 51 and are used for control in the main control unit 51.

In addition to the above-described configuration, as shown in FIG. 4, a memory clear signal (CLR_FIFO) is supplied to the memory 102, a writing pointer clear signal (CLR_WR) is supplied to the writing pointer 104, and a reading pointer clear signal (CLR_RD) is supplied to the reading pointer 105. Although those clear signals (CLR_FIFO, CLR_WR, CLR_RD) are supplied from the main control unit 51 in this embodiment, a circuit for generating those clear signals may be disposed in the laser control unit 55.

Among those clear signals, the memory clear signal (CLR_FIFO) is a signal for clearing the memory 102. When this signal is asserted by the memory 102, the data stored in the memory 102 is cleared (e.g., all zeros). The writing pointer clear signal (CLR_WR) is a signal for clearing the data in the writing pointer 104. When this signal is asserted by a control section of the writing pointer 104, the written data held by the writing pointer 104 is reset to zero. Further, the reading pointer clear signal (CLR_RD) is a signal for clearing the data in the reading pointer 105. When this signal is asserted by a control section of the reading pointer 105, the read data held by the reading pointer 105 is reset to zero.

The reason why those clear signals are used will be described below. The memory 102 is controlled by the writing pointer 104 and the reading pointer 105 such that writing and reading are held in equivalent relation to each other (i.e., data is read in the same amount as data written). At that time, due to noises, etc. superimposed on the clocks (CLK_WR and CLK_RD), there may occur the case where writing and reading are not in equivalent relation to each other. Such a case accompanies a risk of causing an error, e.g., an OVER RUN error or an UNDER RUN error, depending on the memory capacity and the number of data. These errors lead to deterioration of image quality because the data read out of the memory 102 differ from the predetermined data and a desired image is not resulted. In that case, therefore, those clear signals are asserted to return the memory and the pointers to their initial states, followed by starting the image forming operation again.

Also, in the case free from the above-mentioned errors, it is possible to minimize the influence of the errors (deterioration of image quality) by periodically clearing the memory 102 and the pointers 104, 105.

One example most effective in achieving the above purpose is a method of clearing the memory 102 and the pointers 104, 105 whenever one line has been formed. Even if the equivalent relation between writing and reading is lost due to abrupt noise, etc., the resulting influence appears only in one line. Such a method can be realized by arranging the circuit connections so as to make each of the memory clear signal (CLR_FIFO), the writing pointer clear signal (CLR_WR), and the reading pointer clear signal (CLR_RD) outputted in sync with the BD signal. As a result, the memory 102 and the pointers 104, 105 are cleared per line (namely, whenever the BD signal is outputted).

As another example, it is also effective to clear the memory 102 and the pointers 104, 105 whenever the page printing operation is completed. For example, the memory 102 and the pointers 104, 105 are cleared when an EOP signal is at a low level. In other words, the circuit connections are arranged so as to clear the memory 102 and the pointers 104, 105 within an interval between two sheets of paper (sheet interval) in continuous printing operation, and to clear them in periods before and after one sheet of paper in intermittent printing operation. In this example, since a sufficient time margin is ensured for the clear timing, the main control unit (CPU) 51 may also be used to assert the clear signals.

The PWM circuit 55B shown in FIG. 4 executes PWM on a pulse signal in accordance with the image data transferred via the delay control circuit 55A, to thereby produce a PWM modulated signal. The PWM modulated signal is sent as a driving signal (pulse signal) to the laser driver 32. The laser driver 32 drives the laser 31 in accordance with the driving signal.

On the other hand, the control panel 53 is a man-machine interface allowing an operator to, for example, start the copying operation and set the number of copies.

The digital copying machine of this embodiment can operate so as to not only perform the copying operation, but also to form an image by using image data inputted from the outside via the external I/F 59 that is connected to the page memory 58. The image data inputted via the external I/F 59 is temporarily stored in the page memory 58 and then sent to the laser control unit 55 via the image data I/F 56.

Further, when the digital copying machine of this embodiment is controlled from the outside via a network, for example, the external communication I/F 54 takes the role of the control panel 53.

The polygon motor driver 37 is a driver for driving the polygon motor 36 to rotate the polygon mirror 35 for scanning the beam light. The main control unit 51 can control the polygon motor driver 37 so as to start and stop the rotation and to change the rotation speed. The rotation speed is changed as required, for example, when the rotation speed should be reduced from a predetermined speed at the time of confirming the passage position of the beam light by the beam light detector 38.

The laser driver 32 has the functions of not only causing the laser beam to be emitted in accordance with the modulated signal supplied from the laser control unit 55 in sync with scan of the beam light as described above, but also forcibly operating the laser 31 to emit the beam light regardless of the image data in response to a forced light emission signal from the main control unit 51.

Also, the main control unit 51 sets, for the laser driver 32, the power for operating the laser 31 to emit the beam light. The setting of the light emission power is modified depending on, e.g., changes of process conditions.

The memory 52 stores information necessary for the control. For example, the memory 52 stores characteristics (amplifier offset value) of a circuit for detecting the passage position of the beam light and the order of arrival of beam light so that the optical system unit 13 can be brought into a state ready for the image formation immediately after power-on.

The operation and advantages of this embodiment will be described below while laying a focus on the operation and advantages of the laser control unit 55.

The beam light detector 38 serving also as the horizontal sync sensor detects the passage timing of the scan beam light that is scanned by the polygon mirror in the direction indicated by an arrow. In response to the detection, the beam light processing circuit 40 generates a horizontal sync signal (BD).

The BD signal is further supplied to the PWM circuit 55B of the laser control unit 55. Upon receiving the BD signal, the PWM circuit 55B outputs a line sync signal (LSYNC) to the image data I/F 56 in sync with the BD signal.

Upon receiving the LSYNC signal, the image data I/F 56 outputs the image data (DAT_IN) to the delay control circuit 55A of the laser control unit 55 in sync with an image data transfer clock (not shown) that is in turn in sync with the LSYNC signal. Note that, in FIG. 4, the write data clock (CLK_WR) corresponds to the image data transfer clock and DAT_IN represents the image data.

The delay control circuit 55A writes the image data (DAT_IN) in the FIFO memory 102 in an amount within a storable capacity thereof. Then, the delay control circuit 55A reads the image data (DAT_IN) stored in the memory 102 in sync with the read data clock (CLK_RD) and sends read image data (DAT_OUT) to the PWM circuit 55B. The PWM circuit 55B outputs, as a driving signal, a PWM signal modulated in accordance with the received image data (DAT_OUT). The driving signal is outputted to the laser driver 32, whereupon the laser driver 32 drives the laser 31 in accordance with the PWM-modulated driving signal to emit the laser beam in the form of pulsated light.

Regarding the transfer of the image data (DAT_IN) to the PWM circuit 55B, this embodiment is featured in the data writing and reading process executed in the delay control circuit 55A.

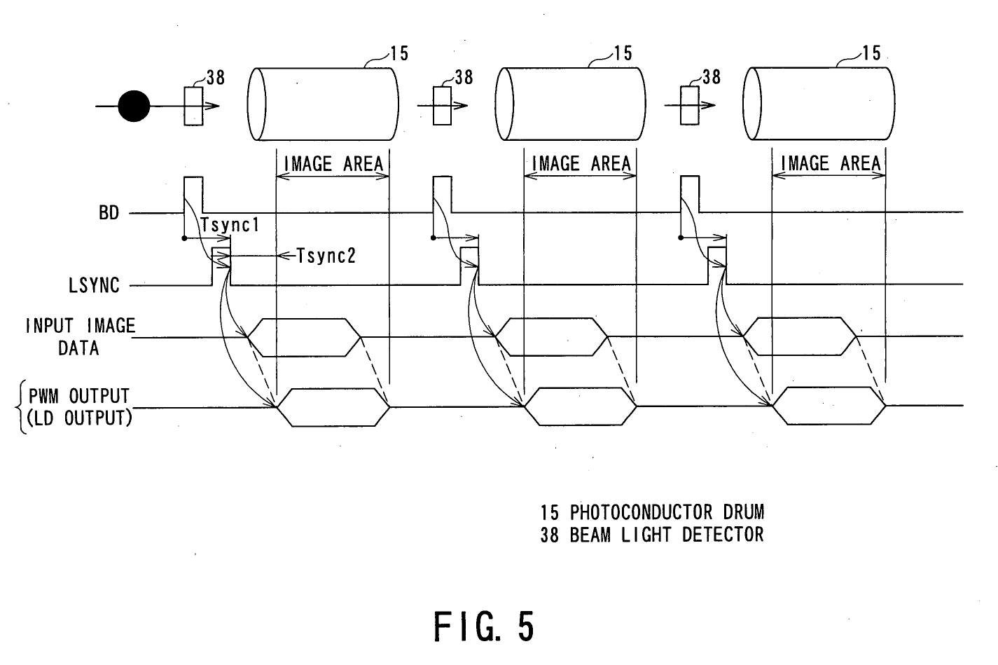

FIG. 5 shows basic time relationships among the BD signal, the LSYNC signal, the image data (DAT_IN) before delay, and the PWM output (PWM modulated signal, i.e., driving signal) resulting from the image data after delay when the beam light reflected by the polygon mirror 35 scans an image area on the photoconductor drum 15.

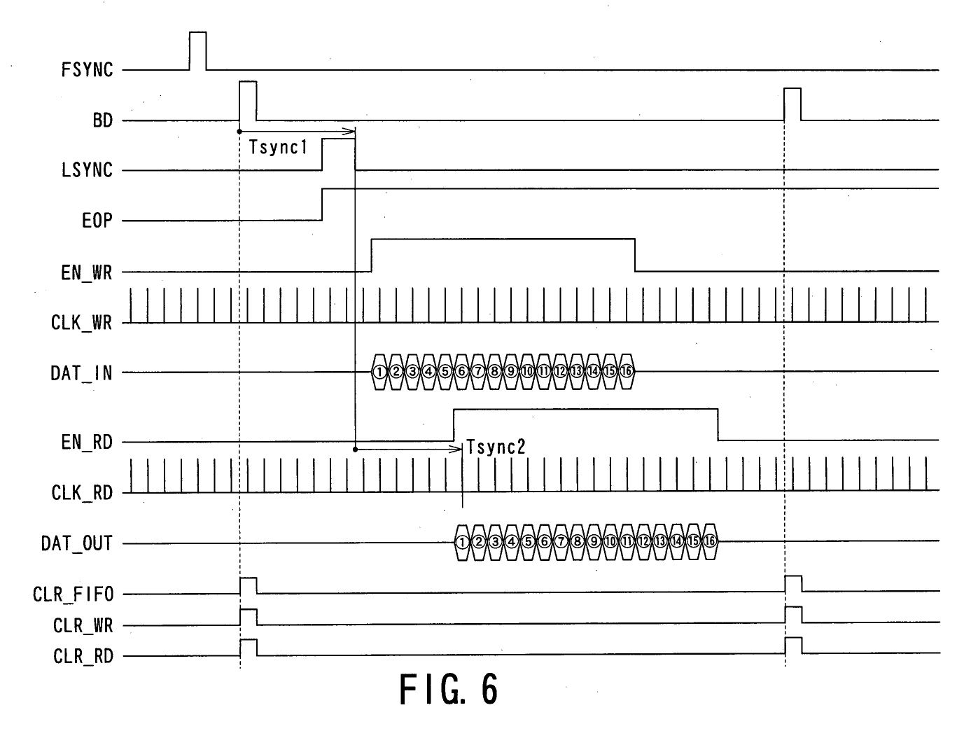

The time relationships shown in FIG. 5 can be depicted in more detail as a timing chart of FIG. 6. The following description is made with reference to FIGS. 5 and 6, as well as the block diagram of FIG. 3.

Upon receiving the BD signal, the PWM circuit 55B outputs the LSYNC signal (line sync signal) to the image data I/F 56 in sync with the BD signal (horizontal sync signal) after a certain delay time Tsync1. Upon receiving the LSYNC signal, the image data I/F 56 makes the write enable signal (EN_WR) effective for writing the data into the FIFO memory 102. Correspondingly, the image data I/F 56 transfers the image data (DAT_IN) to the data latch 101 for the FIFO memory 102 in sync with the data transfer clock (i.e., the write data clock CLK_WR) that is in turn in sync with the LSYNC signal. The data latch 101 latches the data in response to the data transfer clock (CLK_WR).

The write enable signal (EN_WR) and the data transfer clock (CLK_WR) are also connected to the writing pointer 104. The writing pointer 104 executes writing of the image data (DAT_IN) into the memory in such a manner that the data latched by the data latch 101 is written into the memory 102. Thus, the writing pointer 104 manages the number and order (positions) of the written data.

On the other hand, the reading pointer 105 executes management of reading of the image data, which has been written into the memory 102, regarding the number and order (positions) of the read data. The read enable signal (EN_RD) and the read data clock (CLK_RD) are supplied to the reading pointer 105. Thus, in this embodiment, the read data clock (CLK_RD) corresponds to the image formation clock.

When the image data I/F 56 outputs the read enable signal (EN_RD) in sync with the write enable signal (EN_WR) at a predetermined delay time Tsync2, the reading pointer 105 reads the image data, which has been temporarily stored in the memory 102, in the same order as the written data in sync with the read data clock (CLK_RD) and then transfers it, as the image data (DAT_OUT), to the PWM circuit 55B.

A delay amount in reading of the image data can be adjusted by controlling the timing at which the read enable signal (EN_RD) is outputted, exactly speaking, a delay time Tsync2 from the time of the tailing edge of the LSYNC signal to the timing at which the read clock signal (CLK_RD) is made effective by the reading pointer 105.

The delay time Tsync2 can be set in the range of:

0≦Tsync2<maximum value of memory capacity

In principle, the maximum value of the memory capacity means a maximum value of the storage capacity of the memory 102. Because of delays (such as a delay in the writing operation and a delay in the reading operation) occurred in memory peripheral circuits, however, an actually settable delay time is given as a time (or the number of clocks corresponding to the time) obtained by subtracting those delays from the maximum value of the memory capacity. A value set as the delay time depends on the circuit configuration. For example, when the number of pixels per line is 8000 (FIG. 6 shows the number of pixels just by way of illustration), the memory 102 has a capacity of 512 pixels (maximum value). A memory having a capacity equal to or over 1 line is generally called a line memory. A circuit configuration using such a line memory is not intended by the delay control according to the present invention. With the delay control intended by the present invention, the delay is performed within the same line.

The delayed timing represents a point in time at which the processing of the image data of each line has been advanced by the image processing unit 57 and the processed image data has been written in the FIFO memory 102 to some extent. Upon reaching that delayed timing, therefore, the reading of the image data from the FIFO memory 102 is started to form an actual image of each line.

Also, because the above-mentioned read timing of the image data is in sync with the BD signal and the LSYNC signal, there occurs no image deviation in the direction of main scan during the image formation for each line.

Additionally, the EOP signal shown in FIG. 6 represents a signal indicating an image area in the direction of sub-scan (paper feed direction) perpendicular to the direction of main scan in which the beam light is scanned (i.e., a signal indicating an image area in one page). Lines are formed in number corresponding to the number of LSYNC signals outputted in a period during which the EOP signal is effective (i.e., it takes a high level). The EOP signal is also supplied from, e.g., the main control unit 51.

With this embodiment, therefore, even when the transfer speed of the image data is increased, the image data can be transferred at an appropriate point in time after the image processing unit 57 and the image data I/F 56 have started supply of the image data of each line, by setting the delay time Tsync2 to a certain appropriate value.

The advantage with transfer of the image data according to this embodiment will be described below in comparison with drawbacks caused in the related art.

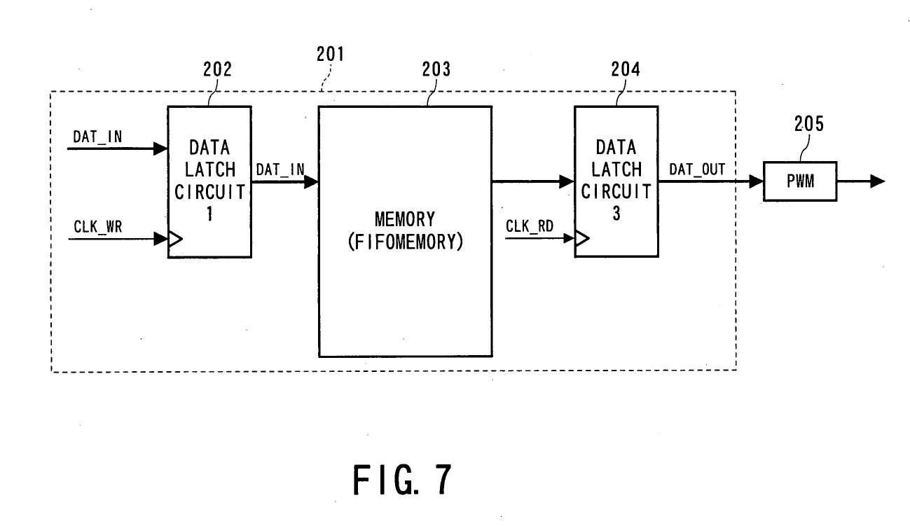

FIG. 7 is a block diagram showing a part of a main control unit 201 in the related art. In this main control unit 201, image data (DAT_IN) transferred from the system side is latched by a data latch circuit 202 using a write clock (CLK_WR), and the latched image data (DAT_IN) is written into an FIFO memory 203. Then, the data written in the memory 203 is read and latched by a data latch circuit 204 in sync with a read clock (CLK_RD). The latched image data (DAT_OUT) is transferred to a PWM circuit 205 and is used for image formation.

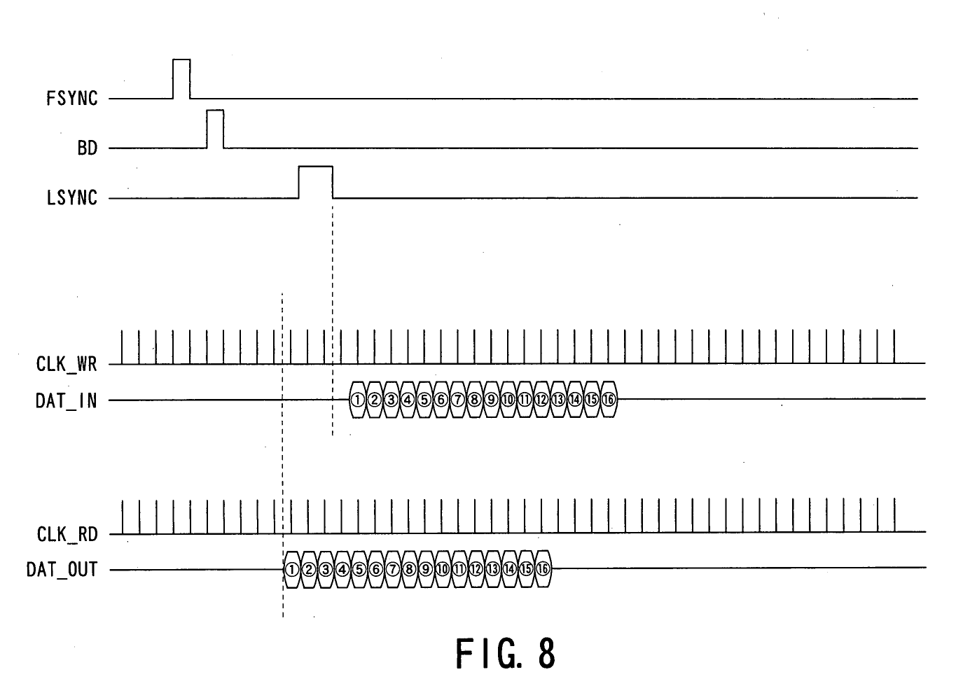

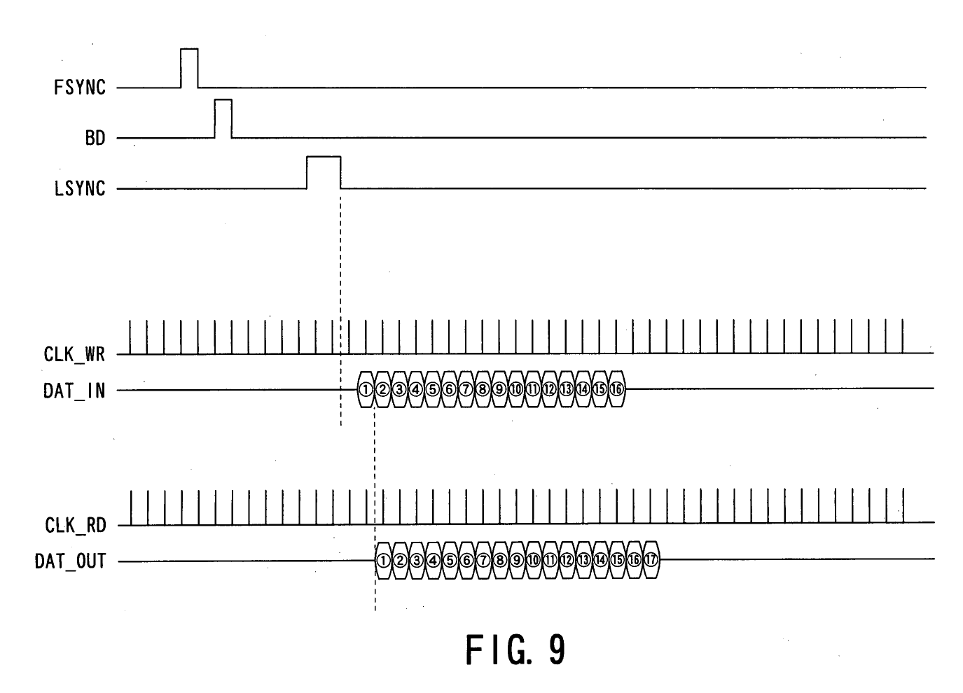

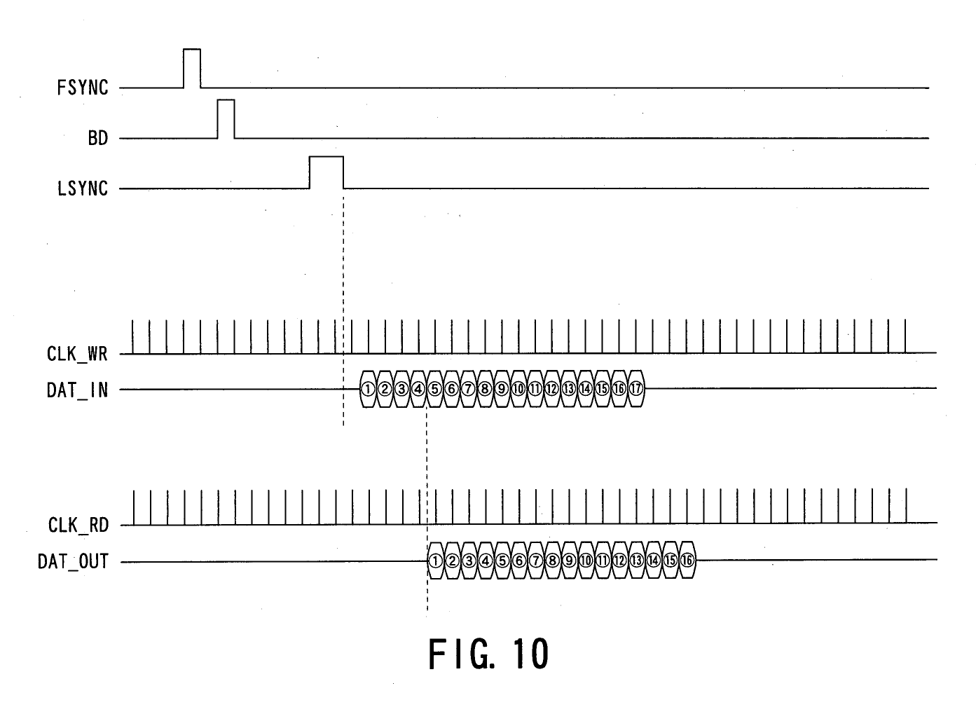

In the case transferring the image data with the related art, however, if the data is read out of the memory 203 before the operation of writing the data into the memory 203 is started, as shown in FIG. 8, desired data cannot be read and the proper relationship between the number of written data and the number of read data with respect to the memory 203 is lost, whereby a desired image cannot be formed. Further, as illustrated in FIGS. 9 and 10, if the number of the write data (DAT_IN) differs from the number of the read data (DAT_OUT), the proper relationship between the number of written data and the number of read data with respect to the memory 203 is also lost, whereby the data in the memory 203 may overflow or may be insufficient. Eventually, a desired image cannot be formed.

More specifically, if the number of read data is larger than the number of written data as shown in FIG. 9, the operation of reading data is performed at a final stage in a state where no data exists in the memory 203 (i.e., in an empty state), and a desired image cannot be formed. Conversely, there may also occur a case where the number of written data is larger than the number of read data, as shown in FIG. 10. Assuming now that the memory has a capacity of 256 pixels and the number of written data is larger than the number of read data by one pixel per line, a shift is caused one pixel by one pixel per line when an image is formed. In addition, the memory becomes full at a 256-th line prior to writing new data, and any data for a next line cannot be stored in the memory. Thus, the memory function is failed and eventually a desired image cannot be formed.

In contrast, according to this embodiment, start and end positions in writing of the image data (DAT_IN) transferred from the image data I/F 56 into the memory 102 are controlled with the write enable signal (EN_WR) on the basis of the BD signal (horizontal sync signal) and the LSYNC signal (line sync signal), as shown in the timing charts of FIGS. 5 and 6, by using the writing pointer 104 and the reading pointer 105 (see FIG. 4). The write enable signal (EN_WR) is set to be in sync with a fall of the LSYNC signal and to rise at a next clock (CLK_WR).

Similarly, the read enable signal (EN_RD) is enabled after the predetermined time Tsync2 from a rise of the write enable signal (EN_WR). The read enable signal (EN_RD) controls start and end positions in reading of the image data out of the memory 102.

With the setting of the delay time Tsynch2, the relationship between the write enable signal (EN_WR) and the read enable signal (EN_RD) is always held such that both the signals (EN_WR, EN_RD) are outputted at the same time, or that the read enable signal (EN_RD) is outputted at later timing than the write enable signal (EN_WR).

This makes it possible to reliably avoid a situation that the operation of reading data out of the memory 102 is performed before data is written into the memory 102 (i.e., in a state where no data exists in the memory 102).

Also, the writing pointer 104 and the reading pointer 105 execute control such that the number of data written during an enable period of the write enable signal (EN_WR) is equal to the number of data read during an enable period of the read enable signal (EN_RD). Consequently, as shown in FIGS. 5 and 6, a desired image can be reliably formed in a predetermined position without destroying the proper relationship between the number of written data and the number of read data with respect to the memory 102.

A series of those operations of writing and reading the image data are executed in sync with one BD signal and one LSYNC signal, and are completed during a processing period that is assigned to the image forming operation for the relevant data of one line.

Thus, the transfer of the image data can be sped up to increase the image printing speed and to realize a finer resolution of the image, while suppressing an increase of the parts cost, with a relatively simple circuit configuration just enough to delay transfer of the image data of each line by a certain time when the image data is transferred.

On the other hand, since the read delay control for the image data is performed during transfer of one line, an FIFO memory is just required with no need of using a relatively expensive line memory. As a result, the cost of parts necessary in the copying machine can be suppressed.

Note that the present invention is not limited to the above-described embodiment, and can be carried out in various forms without departing from the scope of the present invention set forth in claims, as required, in combinations with the known related art.

1. A beam light scanning apparatus comprising:
light emitting means for emitting a beam light for scan;
a memory allowing writing and reading of data based on image information per pixel read from a target image;
data writing means for writing, into the memory, the data of each line in a direction of main scan for the target image in response to a line sync signal;
data reading means for reading the data out of the memory during the same processing cycle corresponding to the line sync signal after a delay of a predetermined time from writing of the data by the data writing means; and
control means for controlling operation of the light emitting means by a driving signal which is generated based on the data read by the data reading means.

2. The beam light scanning apparatus according to claim 1, wherein the memory is a first-in, first-out memory,
the data writing means includes a writing pointer for managing the number of the data written into the memory and data written positions, and
the data reading means includes a reading pointer for managing the number of the data read out of the memory and data read positions.

3. The beam light scanning apparatus according to claim 2, wherein the writing pointer and the reading pointer are each a pointer managing the number of data such that, during the same processing cycle corresponding to the line sync signal, the number of the data written into the memory is equal to the number of the data read out of the memory.

4. The beam light scanning apparatus according to claim 1, wherein the predetermined time is a time satisfying a condition of “0≦the predetermined time<maximum value of memory capacity”.

5. An image forming apparatus comprising:
a beam light scanning apparatus according to claim 1;
an image carrier scanned by a beam light emitted from the light emitting means and forming a latent image thereon; and
a developing unit for developing the latent image formed on the image carrier.

6. A method for controlling generation of a beam light, the method comprising:
writing, into a memory, the data based on image information per pixel of a target image in each line in a direction of main, scan in response to a line sync signal;
reading the data out of the memory during the same processing cycle corresponding to the line sync signal after a delay of a predetermined time from writing of the data in the data writing step; and
controlling operation of light emitting means, which emits a beam light for scan, by a driving signal which is generated based on the read data read.

7. An image forming apparatus comprising:
a beam light scanning apparatus according to claim 2;
an image carrier scanned by a beam light emitted from the light emitting means and forming a latent image thereon; and
a developing unit for developing the latent image formed on the image carrier.

8. An image forming apparatus comprising:
a beam light scanning apparatus according to claim 3;
an image carrier scanned by a beam light emitted from the light emitting means and forming a latent image thereon; and
a developing unit for developing the latent image formed on the image carrier.

9. An image forming apparatus comprising:
a beam light scanning apparatus according to claim 4;
an image carrier scanned by a beam light emitted from the light emitting means and forming a latent image thereon; and
a developing unit for developing the latent image formed on the image carrier.
